(19) United States
(12) Patent Application Publication
(10) Pub. No.: US 2007/0000588 A1
(43) Pub. Date: Jan. 4, 2007

(54) Reduced-weight run flat assembly comprising a pressure-effect structural support

(75) Inventors: Philippe Tramond, St-Ours-Les-Roches (FR); Jean-Charles Lacour, Clermont-Ferrand (FR)

Correspondence Address: COHEN, PONTANI, LIEBERMAN & PAVANE, 551 FIFTH AVENUE, SUITE 1210, NEW YORK, NY, 10176, US

(73) Assignee: Michelin Recherche et Technique S.A., Granges-Paccot (CH)

(21) Appl. No.: 11/479,251

(22) Filed: Jun. 30, 2006

(30) Foreign Application Priority Data
Jun. 30, 2005 (FR) 05/06750

(51) Int. Cl. B60C 17/04

(52) U.S. Cl. 152/158; 152/520

(57) ABSTRACT

A safety assembly (1) for a tire allowing running at reduced pressure. A rim (2) is equipped with a valve, and a tire (4) is mounted on the rim. A structural support (3) rests on the rim (2) and is enclosed in the space between the rim and the internal wall of the tire. The two axially opposed ends (31, 32) of the base (30) of the support (3) form an airtight joint with the part of the rim (2) on which they rest. The space between the rim (20) and the base of the support (30) and situated between the two airtight joints communicates with atmospheric pressure by means of a duct (26).

### FIELD OF THE INVENTION

The invention relates to safety assemblies allowing running at reduced pressure and comprising a rim, said rim being equipped with a valve, a tire mounted on the rim, and a structural support resting on the rim and enclosed in the space between the rim and the internal wall of the tire.

### BACKGROUND OF THE INVENTION

These assemblies and the original elements of which they are composed are known from the prior art and are described in publications EP 0 748 287, EP 0 736 747 or alternatively EP 1 206 357.

These publications disclose safety assemblies allowing running at reduced pressure. In addition to research into the best compromise ensuring the sought-after safety functions, these publications also disclose particular embodiments of the rim and of the support aimed at reducing the total mass of the assembly.

The rims used in the assemblies described above may equally well be of the type with the seat inclined towards the inside or the outside.

The term structural support means a support on which the internal part of the crown of the tire will collapse in the event of a loss of pressure in the tire casing. These supports are made from a material with elastic rigidity which is sufficiently elevated to exhibit sufficient resistance to allow the support to bear the load, but also to render the support sufficiently flexible to absorb impacts. Typically these supports are manufactured from rubber, polyurethanes or alternatively elastomeric thermoplastics.

The supports are subject to the action of a centrifugal force when the vehicle is travelling at high speed, and generally comprise circumferential reinforcement plies situated in the bases of said supports and designed to keep the support in contact with the rim whatever the running conditions of the vehicle. Another possibility consists in creating excess thicknesses of elastomeric material in order to obtain a suitable clamping of the support on the rim.

The use of reinforcement plies is a factor which contributes to an increase in the mass of the support, and the production and assembly thereof generates additional costs.

### SUMMARY OF THE INVENTION

The object of the invention is to eliminate the necessity of reinforcing the structural support to ensure that it is held on the rim whatever the travel speeds of the vehicle.

To this end, it is proposed to form an airtight joint between the two axially opposed ends of the base of the support and the rim on which it rests. The space between the rim and the base is brought into communication with the atmospheric pressure by means of a duct.

When the assembly is pressurised, the volume defined by the internal wall of the tire, the rim and the surface of the support is brought to the utilisation pressure of the assembly, with the exception of the volume between the base and the rim, situated between the two airtight joints, which remains at atmospheric pressure.

The difference in pressure between the two volumes results in a force directed radially towards the inside and acting on the support and having the effect of flattening said support on the rim. This force opposes the centrifugal force and assists in holding the support in position against the rim when the vehicle reaches an elevated speed.

It is thus possible to reduce the weight of the support produced by eliminating all or some of the circumferential reinforcements having the function of holding the support on the rim in the manner of hoops.

### BRIEF DESCRIPTION OF THE DRAWINGS

FIG. 1 is a view in radial section of an assembly according to the invention, showing a first embodiment of the airtight joint,

FIG. 2 is a view in radial section of an assembly according to the invention, showing a second embodiment of the airtight joint,

FIG. 3 is a view in radial section of an assembly according to the invention, showing a third embodiment of the airtight joint.

### DETAILED DESCRIPTION OF THE DRAWINGS

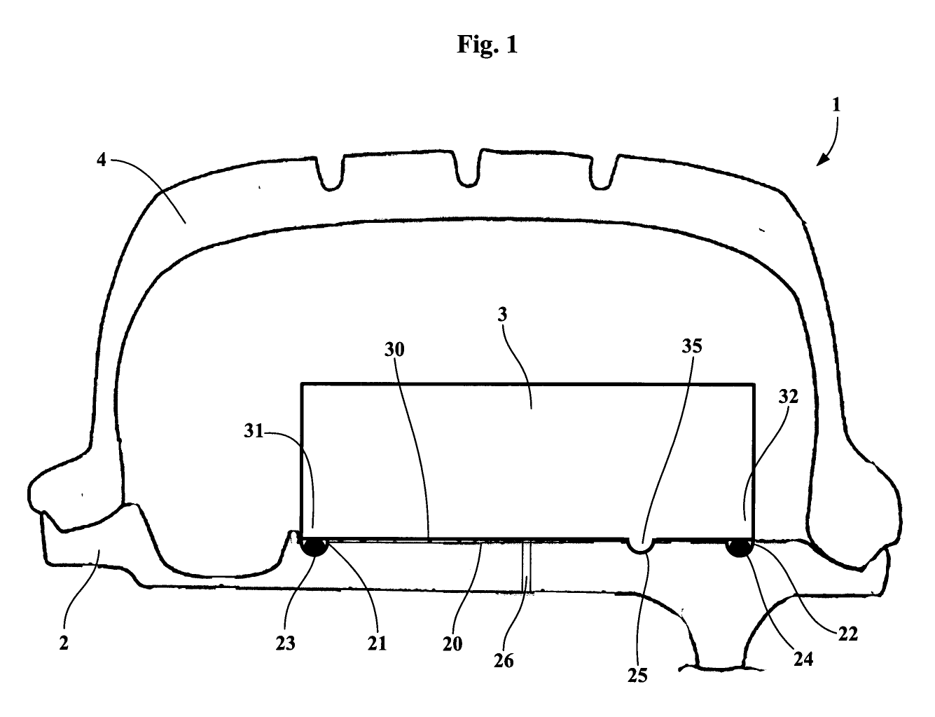

FIG. 1 shows an assembly 1 comprising a rim 2 equipped with an inflation valve (not shown). A tire 4 is mounted on said rim 2 and a structural support 3 is mounted on the rim in the internal space defined by the inner surface of the tire and the rim.

The two opposite axial ends 31 and 32 of the support form an airtight joint with the rim. To this end, two circumferential grooves 21 and 22 are disposed on the rim in line with the ends 31 and 32 of the support. O-ring seals 23 and 24 are placed in the cavities of the grooves 21 and 22 and form airtight joints with the base 30 of the support 3. A duct 26 makes it possible to connect the space between the rim 20 and the base 30 and situated axially between the two airtight joints with the atmosphere.

To prevent the support from moving in the axial direction, it is advisable to form on the rim 3 an additional circumferential groove 25 disposed between the airtight joints provided at the two axial ends 31 and 32 of the base of the support. The support bears a continuous or discontinuous circumferential bead 35, integral with the base and intended to be inserted removably in the groove 25.

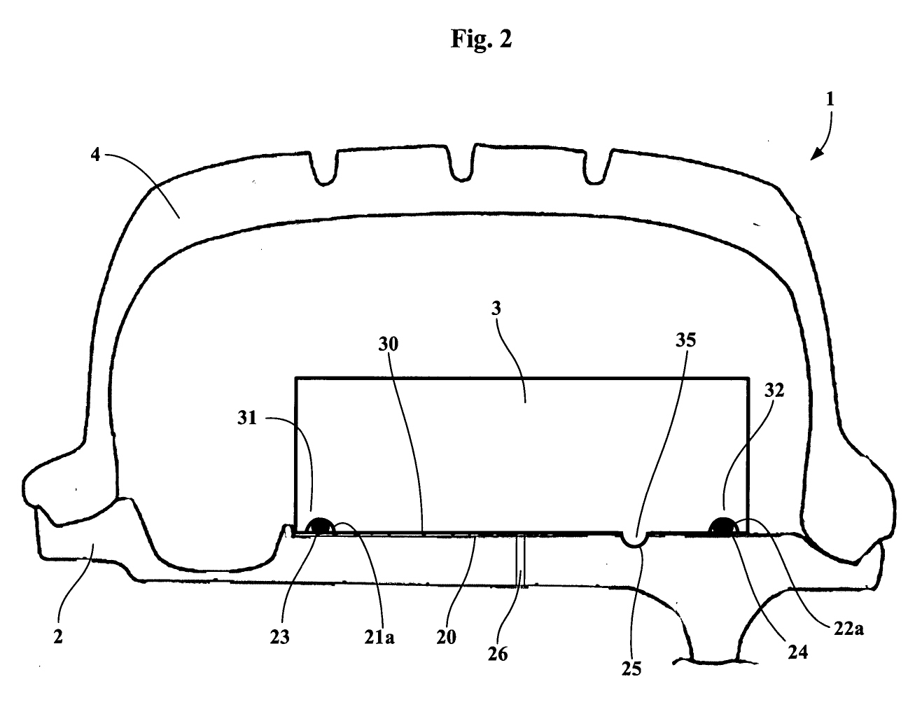

A first alternative embodiment is illustrated in FIG. 2, in which the circumferential grooves 21a and 22a are formed directly in the support 3. The O-ring seals 23 and 24 are placed in the cavities of said grooves 21a and 22a and rest on the inner face 20 of the rim 2 with which they form an airtight joint.

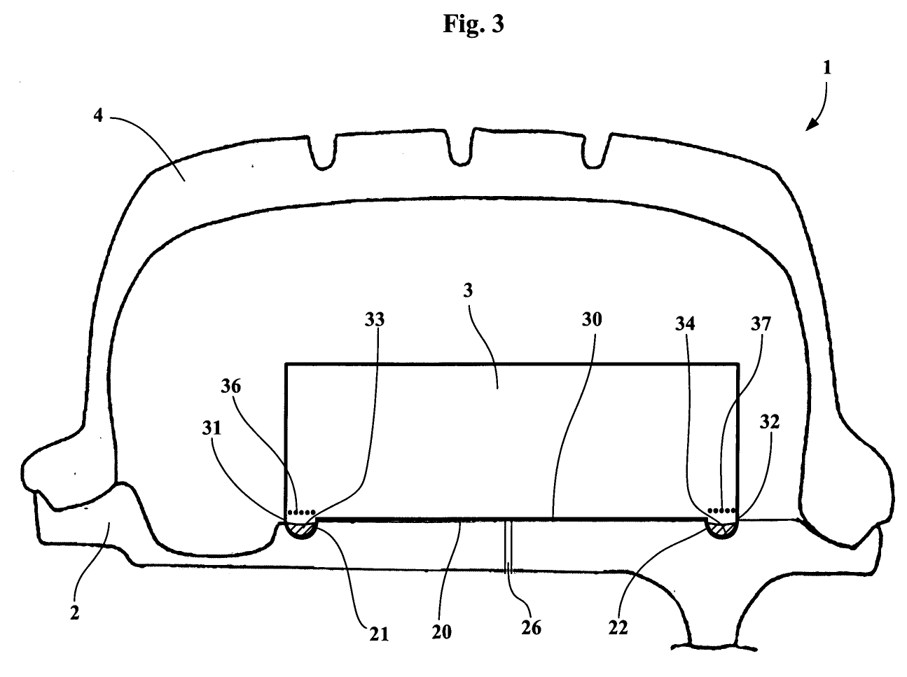

Another embodiment of the airtight joint is illustrated in FIG. 3, the rim comprising two circumferential grooves 21 and 22 situated in line with the axially opposed ends 31 and 32 of the base 30 of the support 3. The support 3 comprises two circumferential beads 33 and 34 situated at each of the axially opposed ends 31 and 32 of the base 30 of the support 3. These beads 33 and 34 are inserted removably in the grooves 21 and 22. The airtight seal is ensured directly by contact between the beads 33 and 34 and the cavities of the grooves 21 and 22. To this end, it is possible to make the beads 33 and 34 of a material suitable for this function which may optionally be different from the material constituting the support, subject to the availability of a manufacturing process capable of producing this combination. It is of course also possible to place gaskets 23 and 24 in the cavities of the grooves 21 and 22 in such a way that the gaskets are compressed by the beads 33 and 34.

This embodiment makes it possible both to ensure that the joint is airtight and to prevent the support from performing any axial movement. It is of course possible to reinforce this lateral stability by disposing on the inner surface of the support, between the two opposite axial ends 31 and 32, discontinuous transverse protuberances (not shown) allowing distribution of the retaining forces over the entire inner surface.

If it is desired to prevent all radial movement of the support at the level of the airtight joints, it is possible to add circumferential reinforcements (36, 37) in the base in line with the ends of the base, as shown in FIG. 3. The addition of these reinforcements makes it possible to increase the threshold speed above which the airtight joint starts to deteriorate, consequently causing the assembly to lose pressure.

The shape and depth of the grooves as well as the shape and diameter of the beads is adapted to ensure easy mounting and demounting of the support while maintaining the quality of the airtight joint between the axially opposed ends of the base and the rim.

FIGS. 1 to 3 are provided for rims described as having outwardly inclined seats and whose seat diameters differ. In addition to its specific nature making it possible to push back the threshold at which the tire rolls of the rim, this method of attachment exhibits the property of allowing easier mounting and demounting of the support and wheel assembly. However, without departing from the spirit of the invention, it is also possible to produce assemblies according to the invention on rims with an inwardly oriented seat profile provided for receiving this type of support, such as, by way of example, a rim in two parts each bearing a seat and connected axially to one another. In this configuration, the join between the two half-rims is advantageously disposed between the two opposite axial ends and connection to the outside air is then naturally effected at the level of said join.

Providing an assembly in accordance with the invention comprising a 4 kg support 80 mm wide, not comprising any circumferential reinforcement and mounted on a wheel 460 mm in diameter supporting a tire inflated to a pressure of 2.2 bar makes it possible to hold the support on the wheel without loss of airtightness up to a speed of 220 km/h.

Producing a reduced-weight support with the above-mentioned dimensions, and in accordance with the invention, makes it possible to reduce the weight of the support by 200 g, but above all to simplify the process of manufacturing the latter.

It goes without saying that it is possible to raise the acceptable limit speed threshold by increasing the width of the support or, as is also suggested above, by disposing the circumferential reinforcements in line with the axially opposed ends of the base of the support, which diminishes some of the advantages of the invention without departing from the spirit thereof. In the case of this latter arrangement, benefit is nonetheless gained from the invention with regard to reducing the weight and consequently the cost of the reinforcements used.

We claim:

1. A safety assembly (1) for a tire to allow travel at reduced pressure, comprising:
a rim (2), said rim being equipped with a valve;
a tire (4) mounted on the rim; and
a structural support (3) having a base (30) resting on the inner face (20) of the rim (2), said structural support being enclosed in a space between the rim and the internal wall of the tire,
wherein each of two axially opposed ends (31, 32) of the base (30) of the structural support (3) forms an airtight joint with the part of the rim (2) on which it rests, and
wherein a space between the rim (20) and the base (30) of the structural support (3) and situated between the two airtight joints communicates with atmospheric pressure by means of a duct (26).

2. The assembly according to claim 1, in which the rim (2) comprises two circumferential grooves (21, 22) situated axially in line with each of the axially opposed ends (31, 32) of the base (30) of the support (3), these grooves having arranged in them O-ring seals (23, 24) forming an airtight joint between the base (30) of the support (3) and the rim (2).

3. The assembly according to claim 1, in which the support (3) comprises two circumferential grooves (21a, 22a) situated axially in line with each of the opposed ends of the base of the support, these grooves having arranged in them O-ring seals (23, 24) forming an airtight joint between the support (3) and the inner face (20) of the rim (2).

4. The assembly according to claim 1, in which the rim comprises at least one additional circumferential groove (25) in which there is inserted in removable manner a circumferential bead (35) integral with the base (30) of the support (3), the purpose being to block movement of the support in the axial direction.

5. The assembly according to claim 1, in which the rim (2) comprises two circumferential grooves (21, 22) in which there are inserted in removable manner two circumferential beads (33, 34) integral with the base (30) of the support (3), disposed in line with each of the axially opposed ends (31, 32) of the base (30)of the support (3) and forming an airtight joint with said rim (3).

6. The assembly according to claim 5, in which the airtight joint between the circumferential beads (33, 34) and the rim is effected by means of gaskets (23, 24) disposed in the cavities of said grooves (21, 22).

7. The assembly according to claim 5, in which the airtight joint between the circumferential beads (33, 34) and the rim (3) is effected by means of the contact between said circumferential beads and the cavities of said grooves (21, 22).

8. The assembly according to claim 7, in which the circumferential beads (33, 34) are made of a different material from that used to produce the support (3).

9. The assembly according to claim 1, in which the supports (3) comprise circumferential reinforcement cords (36, 37) situated in line with the axially opposed ends (31, 32) of the base (3).

10. The assembly according to claim 1, in which the structural support (3) is flattened against the rim (2) under the effect of the inflation pressure.
